(19) United States
(12) Patent Application Publication
(10) Pub. No.: US 2020/0363859 A1
(43) Pub. Date: Nov. 19, 2020

(54) SCALABLE DISPLAYING FOR STRETCHING BATTERY LIFE OF MOBILE DEVICES

(71) Applicant: NVIDIA Corporation, Santa Clara, CA (US)

(72) Inventors: Oliver Yi, Shenzhen (CN); Tiger Yan, Shenzhen (CN); Jacky Zhu, Shenzhen (CN); Joey Cai, Shenzhen (CN)

(21) Appl. No.: 16/452,198

(22) Filed: Jun. 25, 2019

(30) Foreign Application Priority Data
May 13, 2019 (CN) 201910394091.4

(51) Int. Cl. G06F 1/3234; G09G 3/3208; G09G 3/36; G06F 3/0488

(52) U.S. Cl. CPC G06F 1/3265; G06F 3/04886; G09G 3/36; G09G 3/3208

(57) ABSTRACT

Scalable displaying for a mobile device is provided, including receiving an instruction to scale a display of the mobile device, and scaling the display on a screen of the mobile device in response to the instruction. The scalable displaying for the mobile device can be provided by activating only a portion of the screen of the mobile device for use as a display, such that an overall power consumed by the screen is reduced.

### RELATED APPLICATION(S)

The present application claims priority to Chinese Patent Application No. 201910394091.4, filed May 13, 2019, which is herein incorporated by reference in its entirety.

### FIELD OF THE TECHNOLOGY DISCLOSED

The present invention relates to the technical field of electronic devices, and particularly to a scalable displaying method, a mobile device and a storage medium for power savings in mobile devices.

### BACKGROUND

Mobile device displays are a significant consumer of mobile device power. As a result, mobile devices oftentimes provide a “lower power mode” or “low battery mode” to reduce power consumption on the mobile device. Typically, with respect to the mobile device display, these power saving modes have included operating the display at a reduced brightness so that less power is consumed for operating the display. However, the effect of power saving in such a manner is not good enough. When a user expects to prolong service time of the mobile device, a desired result often cannot be obtained in such a manner

### SUMMARY

The present disclosure provides a scalable display to reduce power consumption on the mobile device. The display is scaled by activating only a portion of the screen of the mobile device for use as the display, such that an overall power consumed by the screen is reduced. The scalable display of the present disclosure may or may not be used in combination with the known technique of reducing display brightness to reduce power consumption.

According to one aspect of the present disclosure, a method is provided, comprising:

receiving an instruction to scale a display of a mobile device; and

scaling the display on a screen of the mobile device in response to the instruction.

According to another aspect of the present disclosure, a mobile device is also provided, comprising:

one or more processors;

one or more memories for storing one or more computer programs;

when the one or more computer programs are executed by the one or more processors configuring the mobile device to perform operations comprising:

receive an instruction to scale a display of a mobile device; and

scale the display on a screen of the mobile device responsive to the instruction.

According to yet another aspect of the present disclosure, a storage medium is also provided on which a computer program is stored. When the computer program is operated by at least one processor, the at least processor implements the method according to one aspect of the present disclosure.

A scalable displaying method, a mobile device and a storage medium for power saving in mobile devices according to the present disclosure, scale the display by activating only a portion of the screen of the mobile device for use as the display, such that an overall power consumed by the screen is reduced, which may therefore prolong service time of the mobile device.

### BRIEF DESCRIPTION OF THE DRAWINGS

The following drawings are hereby incorporated as part of the present invention for the understanding of the present invention. The drawings illustrate embodiments of the present invention and depictions thereof for explaining the principle of the present invention. In the drawings:

FIG. 1 illustrates a schematic block diagram of an exemplary electronic device for implementing a method and a mobile device according to an embodiment of the present disclosure;

FIG. 2 illustrates an embodiment of a method for scaling a display of the mobile device to reduce power consumption of the mobile device; the method may be performed using hardware and/or software of the mobile device;

FIG. 3 illustrates a possible hardware configuration of a laptop where the display is scaled with a top left-justified configuration via a screen controller and a GPU;

FIG. 4 illustrates a screen of a laptop where the display is scaled with centered configuration;

FIG. 5 illustrates a screen of a smart phone where the display is scaled with a bottom-justified configuration;

FIG. 6 illustrates a screen of a smart phone showing a gadget (GUI) for selectively enabling operation of the smart phone in a reduced power consumption mode that includes operating with a scaled down display.

FIG. 7 illustrates a schematic block diagram of a computing system according to an embodiment of the present disclosure.

### DETAILED DESCRIPTION

In the following description, numerous specific details are set forth in order to provide a more thorough understanding of the present invention. However, it is obvious to those skilled in this art that the present invention may be implemented without one or more of these details. Some technical features well-known in this art are not described in other examples so as not to confuse with the present invention.

It should be appreciated that the present invention can be implemented in various forms but not limited to the embodiments set forth herein. On the contrary, these embodiments are provided to make the disclosure thorough and complete, and the scope of the invention be completely delivered to those skilled in the art. In the drawings, for clarity purposes, the size and relative dimension of the components, elements, etc. may be exaggerated. The same reference numbers throughout indicates the identical items.

In order to enable the objects, technical solutions and advantages of the present invention to be more apparent, the exemplary embodiments according to the present invention will be described in detail with reference to the drawings. It is obvious that the embodiments described are only a part but not all of the embodiments of the present invention. It is to be understood that the present invention is not limited to the exemplary embodiments described herein. Based on the embodiments described in the present invention, all other embodiments obtained by those skilled in the art without paying any creative work shall be fallen into the protection scope of the present invention.

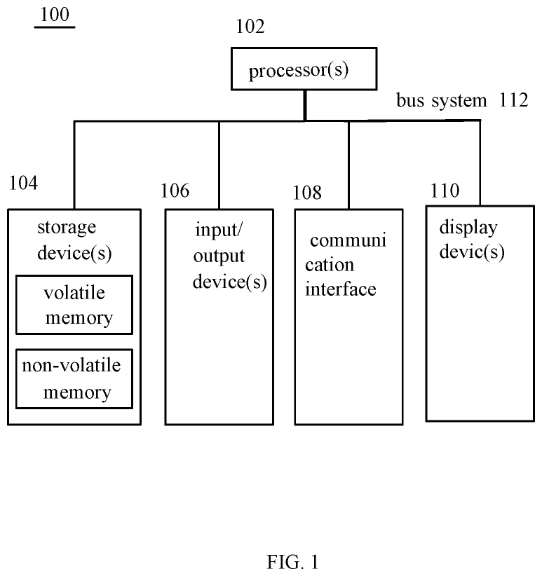

First, with reference to FIG. 1, it illustrates a schematic block diagram of an exemplary electronic device 100 for implementing a method and a mobile device according to an embodiment of the present disclosure. As shown in FIG. 1, the electronic device 100 comprises one or more processors 102, one or more storage devices 104, an input/output device 106, a communication interface 108 and one or more display devices 110. These components are interconnected through a bus system 112 and/or connecting mechanisms (not shown) in other forms. It should be noted that the components and structures of the electronic device 100 as shown in FIG. 1 are merely exemplary but not limited. The electronic device may also comprise other components and structures or may not comprise the aforesaid partial components based on requirements.

The processor 102 typically represents a processing unit of any type or form that can process data or explain and execute instructions. Generally speaking, the processor may be a central processing unit (CPU) or a processing unit in other forms which has data processing capabilities and/or instruction execution capabilities and can control other components in the electronic device 100 to implement desired functions. In the specific embodiment, the processor 102 may receive an instruction from a software application or module. These instructions may cause the processor 120 to realize the functions of one or more example embodiments depicted and/or shown in the text.

The storage device 104 may comprise one or more computer program products, the computer program product may comprise a computer readable storage medium in various forms, e.g., a volatile memory and/or non-volatile memory. The volatile memory may for example comprise a random access memory (RAM) and/or a cache memory (cache), and the like. The non-volatile memory may for example comprise a read-only memory (ROM), a hard disk, a flash memory, and the like. One or more computer program instructions may be stored on the computer readable storage medium. The processor 102 may run the program instructions to realize the client functions in the embodiments of the present invention (realized by the processor) as described below and/or other desired functions. Various application programs and data may be also stored in the computer readable storage medium, such as the various data used and/or generated by the application programs, and the like.

The input/output device 106 may be a device with which a user inputs instructions and outputs various information outwards. For instance, the input device may comprise one or more of a keyboard, a mouse, a microphone and a touch screen, and the like. The output device may comprise one or more of a display and a loudspeaker, etc.

The communication interface 108 broadly represents an adaptor or a communication device of any type or form which can promote communication between the exemplary electronic device 100 and one or more auxiliary devices. For instance, the communication interface 108 may promote communication of the electronic device 100 with a front-end or an accessory electronic device and a back-end server or the cloud. The example of the communication interface 108 comprises but is not limited to a wired network interface (e.g. a network access card), a wireless network interface (e.g. a wireless network interface card), a modem and any other suitable interfaces. In one embodiment, the communication interface 108 provides direct connection to a remote server/remote front-end device through a direct connection with the network such as Internet. In a specific embodiment, the communication interface 108 provides a direct connection to the remote server/remote front-end device through a direct connection with dedicated networks, such as a video surveillance network, and a skynet system network, and the like. The communication interface 108 may also indirectly provide such a connection through any other suitable connections.

A display device 110 comprises various display devices, e.g. a liquid crystal display (LCD) or an organic light-emitting diode (OLED) display. The display device 110 may further comprise a display controller such as a LCD controller for controlling/driving the display of the display device 110, e.g. brightness, refresh rate of the display device, to drive the display device 110 to display the specific colors and contents.

Exemplarily, the exemplary electronic device for implementing the scalable displaying method and the mobile device according to embodiments of the present disclosure may be realized as portable electronic devices or battery powered electronic devices such as a smart phone, a tablet computer, a laptop, and the like.

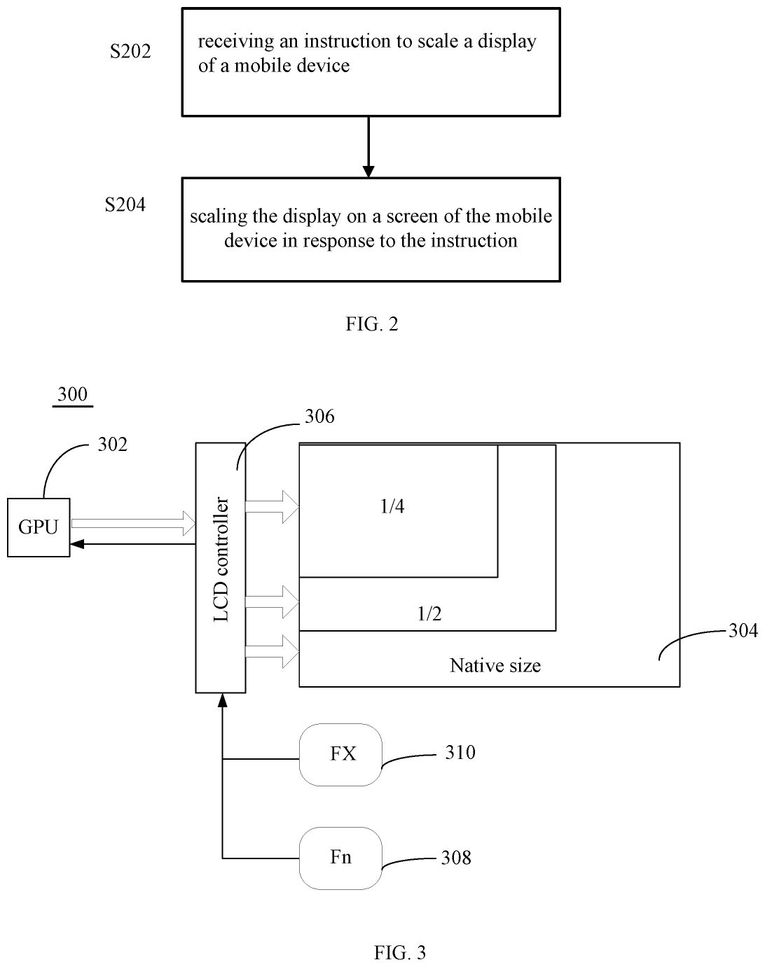

With reference to FIG. 2 below, it illustrates a method for scaling a display of a mobile device to reduce power consumption thereof according to embodiments of the present disclosure.

FIG. 2 illustrates one embodiment of a method for scaling a display of a mobile device to reduce power consumption on the mobile device. The method may be performed using hardware and/or software of the mobile device, and the method as shown in FIG. 2 comprises:

In step S202, an instruction to scale a display of a mobile device is received. In the context of the present method, scaling the display includes down-sizing the display of the mobile device for presentation on just a portion of the entire screen of the mobile device, such that a remaining portion of the screen of the mobile device (not showing the display) is deactivated for power saving purposes. Thus, in the context of the present description, the display refers to the graphical user interface (GUI) presented on an activated (e.g. illuminated. etc.) portion of the screen of the mobile device for viewing by a user of the mobile device.

In one embodiment, the instruction may be triggered automatically based on the battery status of the mobile device. For example, the instruction may be triggered when the battery reaches a threshold level. The threshold level may be predefined and/or configured by a user of the mobile device. In another embodiment, the instruction may be triggered on-demand by the user of the mobile device selecting an option to scale the display (e.g. a sliding tool with values ranging from 0% to 100% of the original size of the display), or selecting an option to operate the mobile device in a reduced power consumption mode that includes operating with a scaled down display.

In another embodiment, the instruction may indicate an amount to scale the display of the mobile device. The amount may be a percentage of an original size of the display. For example, the amount may be 75%, 50%, or 25% of the original size of the display or a full size of the screen of the mobile device. As an option, the amount to scale the display may be a function of the battery status of the mobile device. Thus, as the battery level of the mobile device decreases, the display size may also be decreased. As another option, the amount to scale the display may be selected by the user of the mobile when selecting the option to scale the display, as described above.

In one embodiment, the instruction may indicate an area of the screen to present the scaled display, or in other words the area of the screen to be activated. For example, the scaled display may be centered on the screen of the mobile device. As another example, the scaled display may be top left-justified on the screen of the mobile device. It should be noted that centering the scaled display on the screen may require more mathematical calculations than top-left justifying the scaled display on the screen in order to determine equal left/right and equal top/bottom portions of the screen to deactivate.

In step S204, the display of the mobile device is scaled on the screen in response to the instruction. The display may be scaled by the amount indicated by the instruction, or a predefined amount, thereby reducing a resolution of the display. Since the active area of the screen is reduced, less power is consumed by the screen (that is, the power consumed by the screen is reduced).

In one embodiment, the display of the mobile device is scaled via a screen controller (e.g. liquid crystal display (LCD) controller) and a graphics processing unit (GPU) of the mobile device. The screen controller and the GPU are notified of the instruction to scale the display. As a result, the GPU outputs the scaled display (i.e. scaled GUI) and the screen controller sends the scaled display to only the area of the screen to be activated. In the present embodiment, the portion of the screen is activated by turning ON a portion of a backlight of the mobile device corresponding to the portion of the screen, for presenting the scaled display on the screen for viewing by the user. The remaining portion of the backlight is turned OFF for deactivating a remaining portion of the screen.

Further to the above embodiment, timing configuration settings of the screen controller may be updated. The timing configuration settings may be updated only for the portion of the screen to be deactivated, to at least temporarily prevent the screen controller from sending pixel data to the portion of the screen to be deactivated, or otherwise reduce the frequency at which the screen controller sends pixel data to the portion of the screen to be deactivated.

In another embodiment, particularly where the screen is an organic light-emitting diode (OLED) screen that is already configured for selectively activating a backlight for portions of a screen, the scaling of the display and the control of the backlight may be provided using the GPU (e.g. without any hardware changes required for the screen controller as otherwise required in the embodiment described above). In particular, in response to the instructions, the GPU may output pixel data for an entire area of the screen ,wherein the pixel data for the portion of the screen to be activated presents the scaled-down display and the pixel data for the portion of the screen to be deactivated is black. By the GPU driving the back to the portion of the screen to be deactivated, the OLED screen will automatically deactivate the backlight for that portion of the screen, thus providing power saving.

FIG. 3 illustrates a possible hardware configuration of a laptop 300 where the display is scaled with a top left-justified configuration via the screen controller and the GPU.

In this embodiment, the scaled display, which is implemented according to the present disclosure, is described by taking the laptop 300 as an example. The electronic device 100 as shown in FIG. 1 may be referred for the configuration of the laptop 300. FIG. 3 only illustrates partial configurations of the laptop 300, e.g. a graphics processing unit (GPU) 302, a display device 304. The graphics processing unit (GPU) 302 may be independently disposed or integrated with the processor or belong to a part of the processor. The graphics processing unit (GPU) 302 is used to generate/output the pixel data, which is sent to the display device 304 for display in order to view by a user of the laptop 300. In this embodiment, the display device 304 is a liquid crystal display (LCD), and the display device 304 comprises a LCD controller 306 for controlling/driving the display of the display device 304, e.g. controlling the brightness and refresh rate of the display device. And so on, to drive the display device 304 to display the particular color and content for viewing by a user of the laptop 300. In this embodiment, the LCD controller 306 may also be integrated with a display chip/circuit or a control chip/circuit which may control the backlight of the display device 304, e.g. enabling a part of the backlight of the display device 304 to be in an ON state and another part thereof in an OFF state via the display chip/circuit or the control chip/circuit. For example, the backlight corresponding to the activated portion of the screen of the laptop 300 is in an ON state, while the backlight corresponding to the deactivated portion of the screen of the laptop 300 is in an OFF state.

In the present embodiment, the scaled display of the laptop 300 is triggered by function key Fn308 and FX310 on the keyboard of the laptop 300. For example, the function keys Fn+F8 are configured when it is pressed down, the scaled display of the laptop 300 is triggered. Certainly, the scaled display of the laptop 300 may also be triggered by other manners, e.g. by control options of the display device 304 or other setting options. When the options of the configured laptop 300 is triggered, an instruction to scale the display is received by the graphics processing unit (GPU) 302 and the LCD controller 306 of the laptop 300. The graphics processing unit (GPU) 302 subsequently outputs the scaled display (i.e. the scaled GUI), and the screen controller 306 sends the scaled display only to an area of the display device 304 to be activated. In this embodiment, the area of the display device 304 to be activated is configured in a top left-justifying manner That is, if the size of the scaled display is ¼ of the original size, the top-left ¼ area of the display device 304 is an area to be activated. If the size of the scaled display is ½ of the original size, the top-left ½ area of the display device 304 is an area to be activated. As illustrated above, the percentage of the scaled display may be included in a triggering instruction of the scaled display. As an example, after the function keys Fn+F8 are pressed down, the instruction to scale the display is triggered, and meanwhile the instruction further indicates that the percentage of the scaled display is ½. In the embodiment, the function keys Fn+F8 may be further configured to trigger a further scale display instruction when it is pressed again, for instance, the percentage to scale the display changes from ½ to ¼.

In the embodiment, as illustrated above, the display device 304 is activated by turning ON a portion of the backlight corresponding to the portion for presenting the scaled display. The remaining portion of the backlight is turned OFF for deactivating the remaining portion of the screen. Thus, the deactivated portion of the display device 304 is electrically turned OFF to reduce power consumption by the display device 304 and prolong the usage time of the battery of the laptop 300. As an example, if the display device 304 consumes 50% power of the entire system of the laptop 300, and if the display device 304 is operated with a ½ scaled display at 100% power supply level, the working time of the laptop 300 may prolong 33.3%; if the display device 304 is operated with a ¼ scaled display at 100% power level, the working time of the laptop 300 may prolong 60%.

It should be appreciated that in this embodiment, the function keys Fn308 and FX310 as an option to trigger the scaled display are exemplary but not limited. The percentage of the scaled display is also exemplary but not limited. Those skilled in the art may make suitable configuration as needed. For example, as explained above, the laptop 300 may be configured to trigger an instruction to scale the display when its battery level is below a threshold level, such as below 20%. For another example, when the laptop 300 enters a lower power mode, an instruction to scale the display is triggered.

It should be further appreciated that in the embodiment, although the display is scaled by electrically turning OFF a portion of the backlight of the display device 304 to reduce power consumption of the display device 304 and prolong the usage time of the battery of the laptop 300, it may or may not be used in combination with the known technique of reducing display brightness to reduce power consumption. That is, while the scaled display is performed, the power consumption of the display device 304 is further reduced while the brightness of the area of the display device 304 for presenting the scaled display can be reduce.

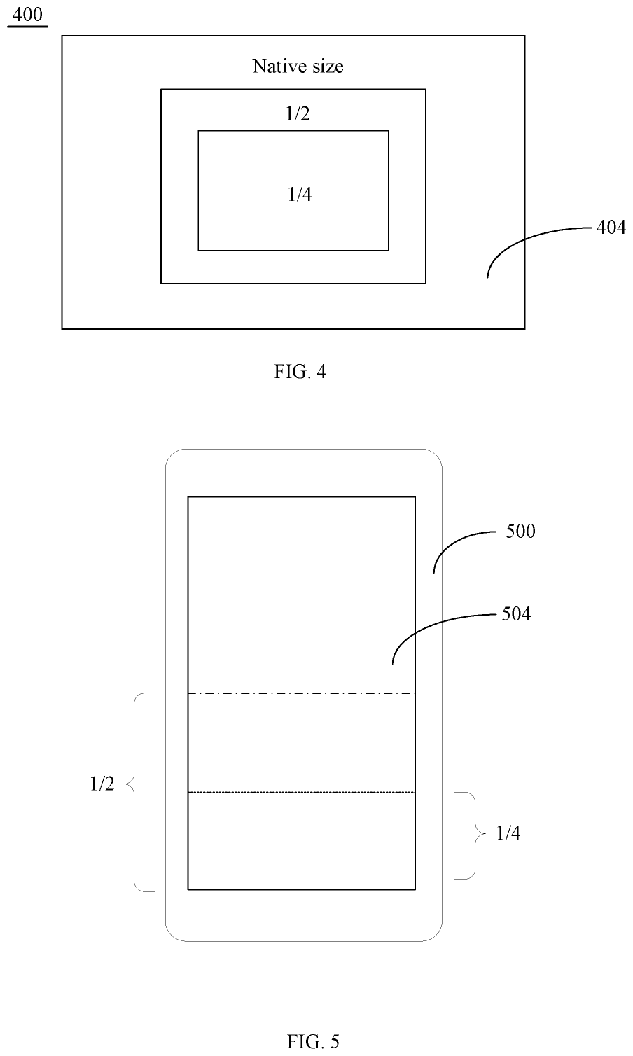

FIG. 4 illustrates a screen of a laptop 400, wherein the display is scaled with centered configuration. As shown in FIG. 4, in this embodiment, the scaled display implemented according to the present disclosure is still described by taking the laptop as an example. Different from the embodiment shown in FIG. 3, in this embodiment, the scaled display of the display device 404 of the laptop 400 is implemented in a centered manner, rather than in the top left-justified manner As shown in FIG. 4, when the instruction to scale the display is triggered, the area of the display device 404 to be activated is configured in a centered manner That is, if the size of the scalable display is ¼ of the original size, the centered ¼ area of the display device 404 is an area to be activated. If the size of the scalable display is ½ of the original size, the centered ½ area of the display device 404 is an area to be activated.

Please refer to the description in the part of FIG. 3 for other processes of the scalable display disclosed in this embodiment, which would not be repeated here.

FIG. 5 illustrates a screen of a smart phone 500 where the display is scaled with a bottom-justified configuration. As shown in FIG. 5, in this embodiment, the scalable display implemented according to the present disclosure is described by taking the smart phone 500 as an example. The electronic device 100 as shown in FIG. 1 may be referred for the configuration of the smart phone 500. FIG. 5 only shows a partial configuration of the smart phone 500, e.g. the display device 504. In this embodiment, the display device 504 comprises a display screen and a touch unit. Exemplarily, the display screen is an organic light-emitting diode (OLED) screen. As compared with the liquid crystal display (LCD), the organic light-emitting diode (OLED) screen does not need to use the LCD controller and may be configured to selectively activate a light-emitting unit for a portion of the screen. The scaling of the display and the control of the illumination can be implemented by use of GPU (the GPU may be integrated in the system on chip SOC). That is, pixel data output by the GPU may be presented on the portion of the OLED screen or an entire area by driving the light emitting portion of the OLED screen. For an OLED screen, the area not to be displayed is driven to be black, and thus it may reduce power consumption of the display device 504.

In this embodiment, when an instruction to scale the display is triggered, in response to the instruction, the GPU may output pixel data for an entire area of the screen, wherein the pixel data for the portion of the screen to be activated presents the scaled-down display and the pixel data for the portion of the screen to be deactivated is black. By the GPU driving back to the portion of the screen to be deactivated, the OLED screen will automatically deactivate the backlight for that portion of the screen, thus providing power saving.

Referring back to the FIG. 5, in this embodiment, when an instruction to scale the display is triggered, the area of the display device 504 to be activated is configured in a bottom-justified manner That is, if the size of the scalable display is ½ of the original size, the ½ area from bottom upwards of the display device 504 is an area to be activated. If the size of the scalable display is ¼ of the original size, the ¼ area from bottom upwards of the display device 504 is an area to be activated. It should be appreciated that the scalable percentage ½ or ¼ provided in the embodiment is only exemplary but not limited, for example, the scalable percentage may also be ⅓ or ¾, and the like.

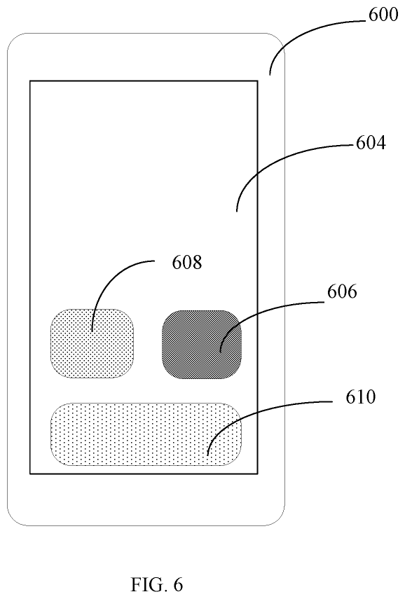

FIG. 6 illustrates a screen of a smart phone 600 showing a gadget (GUI) for selectively enabling the operation of the smart phone 600 in a reduced power consumption mode that includes operating with a scaled down display.

As shown in FIG. 6, in this embodiment, the scalable display implemented according to present disclosure is described by taking the smart phone 600 as an example. The electronic device 100 as shown in FIG. 6 may be referred for the configuration of the smart phone 600. FIG. 6 only illustrates a partial configuration of the smart phone 600, e.g. the display device 604. Tool options (or plug-ins) 606, 608 and 610 are configured on the display device 604. The tool options (or plug-ins) 606, 608 and 610 are configured to be operated by a user of the smart phone 600 such that the smart phone 600 is operated with a scaled display or in a reduced power consumption mode that includes operating with a scaled down display. As an example, when the tool option (or plug-in) 606 is operated by a user of the smart phone 600, the instruction to scale the display is triggered, or the instruction to operate the smart phone 600 in a reduced power consumption mode is triggered. The reduced power consumption mode includes operating with a scaled down display. Subsequently, the display device 604 of the smart phone 600, e.g. the OLED display screen or the liquid crystal display (LCD), receives pixel data output by the GPU or GUI of scaled display and displays the scalable display in the area of the display device 604 to be activated. The area of the display device 604 to be activated may be configured in a manner of top left-justified, centered, or bottom-justified manner on the screen of the smart phone 600 as described above. The percentage of the scalable display may be configured in the tool option (or plug-in) 606. For example, when the tool option (or plug-in) 606 is operated, it represents the display is scaled at a ½ percentage. As another example, when the tool option (or plug-in) 608 is operated, it represents that the display is scaled at a ¼ percentage. As another example, when the tool option (or plug-in) 610 is operated, the percentage of the scalable display may be directly configured in the tool option (or plug-in) 610 and adjusted by sliding on the tool option (or plug-in) 610, e.g. in a range of 0% to 100% of the original size to be displayed.

It should be appreciated that the tool options (or plug-ins) 606, 608, 610 are only exemplary. The smart phone 600 may comprise only one of the tool options and also more tool options, and the tool options (or plug-ins) 606, 608, 610 may be configured on the pull-down menu, popup-menu, settings or shortcut options of the smart phone 600.

It should be further appreciated that although in this embodiment, the scalable display is explained in a top left-justified, centered, and bottom-justified manner, the present disclosure is not limited thereto, for example, the scalable display may also be configured in a top right-justified, lower left-justified, lower right-justified, top justified manners. In addition, the trigger option of the scalable display is not limited to the function keys Fn+Fx of the laptop and the tool options (or plug-ins) of the smart phone either, and may also be other entity keys or virtual options of the laptop or the smart phone. For example, the power switch of a smart phone may be configured to enable the smart phone enters a scalable display mode or a lower power consumption mode that includes operating the smart phone with a scaled down display when it is longpressed for a set time. Take another example, the specific operation (e.g. sliding operation) in the specific area of a smart phone or laptop may trigger an instruction to enable the smart phone or the laptop to enter the scalable display mode or the lower power consumption mode that includes operating the smart phone with a scaled down display.

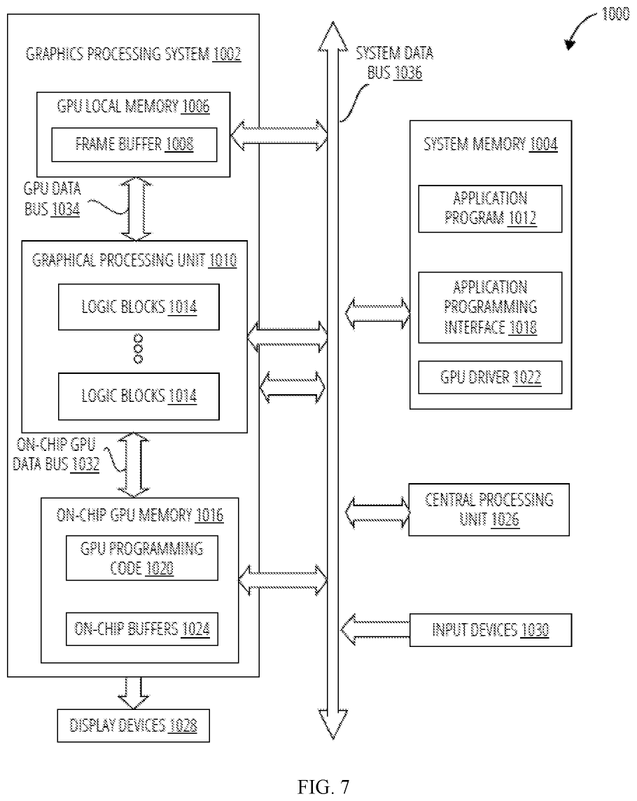

FIG. 7 illustrates a schematic block diagram of a computing system 1000 according to an embodiment of the present disclosure in which one or more aspects of the present disclosure may be achieved. The computing system 1000 comprises a system data bus 1036, a CPU 1026, an input device 1030, a system storage 1004, a graphics processing system 1002 and a display device 1028. In alternate embodiments, the CPU 1026, portions of the graphics processing system 1002, the system data bus 1036 or any combination thereof, may be integrated into a single processing unit. In addition, the functionality of the graphics processing system 1002 may be included in a chip set or some other types of dedicated processing units or coprocessors.

As shown in FIG. 7, the system data bus 1036 connects the CPU 1026, the input device 1030, the system memory 1004 and the graphics processing system 1002. In alternate embodiments, the system memory 1004 may be directly connected to the CPU 1026. The CPU 1026 receives a user input from the input device 1030, executes programming instructions stored in the system memory 1004, operates data stored in the system memory 1004, and configures the graphics processing system 1002 to perform the specific task in a graphics pipeline. The system memory 1004 generally comprises a dynamic random access memory (DRAM) for storing the programming instruction and data processed by the CPU 1026 and the graphics processing system 1002. The graphics processing system 1002 receives the instructions transmitted by the CPU 1026 and processes the instruction to execute various operations within the computing system 1000.

As shown in FIG. 7, the system memory 1004 comprises an application program 1012, an API 1018 (application programming interface) and a graphics processing unit driver 1022 (GPU driver). The application 1012 generates a call to the API 1018 to produce a required set of results. For example, the application program 1012 may further transmit programs to the API 1018 to perform shading operations, artificial intelligence operations, or graphics rendering operations. The function of the API 1018 may be generally achieved in the graphics processing unit driver 1022. The graphics processing unit driver 1022 is configured to translate the high-level shading programs into a machine code.

The graphics processing system 1002 comprises a GPU 1010 (a graphics processing unit), an on-chip GPU memory 1016, an on-ship GPU data bus 1032, a GPU local memory 1006 and a GPU data bus 1034. The GPU 1010 is configured to communicate with the on-chip GPU memory 1016 via the on-chip GPU data bus 1032 and communicate with the GPU local memory 1006 via the GPU data bus 1034.

The GPU 1010 may receive an instruction transmitted by the CPU 1026 and store results in the GPU local memory 1006. Subsequently, if the instruction is a graphics instruction, the GPU 1010 may display some graphic images stored in the GPU local memory 1006 on the display device 1028.

The GPU 1010 comprises one or more logic blocks 1014. The logic block 1014 may be uploaded on the GPU as an instruction, and also realized in a circuit as an instruction set architectural feature, or a combination thereof.

The GPU 1010 may further comprise any number of an on-chip GPU memory 1016 and a GPU local memory 1006, including none, and may perform the memory operation by use of the on-chip GPU memory 1016, the GPU local memory 1006 and the system memory 1004 in any combination.

The on-chip GPU memory 1016 is configured to comprise a GPU programming 1020 and an on-chip buffer 1024. The GPU programming 1020 may be transmitted from the graphics processing unit drive program 1022 to the on-chip GPU memory 1016 via the system data bus 1036.

For example, the GPU programming 1020 may comprise a machine code vertex shader, a machine code geometry shader, a machine code segment shader, an artificial intelligence program or a variant of any number of each program. The on-chip buffer 1024 is generally used to store data which need to be rapidly accessed to reduce delay of such operations.

The GPU local memory 1006 generally comprises a less expensive off-chip dynamic random access memory (DRAM) and is also used for storing data and program used in the GPU 1010. As shown in the figures, the GPU local memory 1006 comprises a frame buffer 1008 for storing data of at least one two-dimensional surface for driving the display device 1028. In addition, the frame buffer 1008 may comprise more than one two-dimensional surface so that the GPU 1010 may be rendered to one two-dimensional surface and meanwhile use the second two-dimensional surface to drive the display device 1028.

The display devices 1028 are one or more output devices that can send out visual images corresponding to the input data signals. For example, the display devices may be constructed by use of a cathode-ray tube (CRT) monitor, a liquid crystal display or any other appropriate display systems. The input data signals sent to the display device 1028 are generally generated by scanning out the contents of one or more frames of the image data stored in the frame buffer 1008.

In addition, a storage medium is further provided according to the embodiment of the present invention. The program instruction is stored on the storage medium for performing the corresponding steps of the scalable display method for mobile devices according to the embodiments of the disclosure and respective functional modules of the mobile devices when the program instruction is operated by the computer or the processor. The storage medium may comprise, for example, a memory card of the smart phone, a memory component of a tablet personal computer, a hard disk of a personal computer, a read-only memory (ROM), an erasable programming read-only memory (EPROM), a portable compact disk read-only memory (CD-ROM), a USB memory, or any combination of the above storage medium. The computer readable storage medium may be any combination of one or more computer readable storage medium. For example, one computer readable storage medium comprises a computer readable program code for image acquisition, and another computer readable storage medium comprises a computer readable program code of the scalable display method for mobile devices.

In one embodiment, when the computer program instructions are operated by the computer, it may implement respective functional modules of the mobile devices, and/or the scalable display method for the mobile devices according to the embodiment of the present disclosure.

In one embodiment, when the computer program instructions are operated by the computer, it implements the steps of: receiving an instruction to scale the display of the mobile device; and scaling the display on a screen of the mobile device responsive to the instruction.

A scalable displaying method, a mobile device and a storage medium for power saving in mobile devices according to the present disclosure, scale the display by activating only a portion of the screen of the mobile device for use as the display, such that an overall power consumed by the screen is reduced, which may therefore prolong the usage time of the mobile device.

Although the example embodiments have been described with reference to the drawings herein, but it is to be understood that the above-described example embodiments are for illustrative purposes only and are not intended to limit the scope of the invention thereto. Those of ordinary skill in the art can make various variations and modifications therein but not deviate from the scope and spirit of the present invention. All these variations and modifications are intended to be included within the scope of the invention as claimed by the claims attached.

Those of ordinary skill in the art may be aware that the units and algorithmic steps of respective examples described in the embodiments disclosed in the context can be realized in conjunction with an electronic hardware, or a combination of computer software and electronic hardware. Whether these functions are implemented in a manner of a hardware or a software depends on the specific application and design constraint conditions of the technical solution. The technical professionals may realize the described function of each specific application using different methods; however such realization should not be deemed as exceeding the scope of the present invention.

In several embodiments provided by the present application, it should be appreciated that the disclosed device and method may be implemented by other means. For example, as described above, the device embodiments are only for illustrative purposes. For example, the division of the units is merely a division of logical functions, and there may be other dividing manners in real implementation. For example, multiple units or components may be combined or integrated into another device, or some features may be ignored or not be implemented.

Numerous specific details are set forth in the description provided herein. However, it can be understood that the embodiments of the present invention may be practiced without these specific details. The well-known method, structure and technique are not illustrated in detail in some examples so as not to confuse the understanding on this description.

Similarly, it is to be understood that respective features of the present invention are sometimes grouped into the single embodiment, the drawing, or the description thereof in the description of the exemplary embodiments of the present invention, in order to simplify the present invention and facilitate understanding of one or more aspects of the invention. However, the method of the present invention shall not be explained to reflect the following intention, that is, the claimed present invention claims more features than those explicitly recited in each claim. To be more accurate, as reflected by the corresponding claims, the inventive ideas thereof lie in that the corresponding technical problem may be resolved with the feature fewer than all features of the single embodiment of some disclosure. Thus, the claims complying with the embodiments are hereby explicitly incorporated into the embodiments, wherein each claim itself serves as an independent embodiment of the present invention.

It would be understood by those skilled in the art that, any combination, except the mutually exclusive features therebetween, may be used to combine all features disclosed in this description (including the claims, abstract and accompanying drawings that follow) and any method disclosed hereby or all processes or units of the device. Each feature disclosed in this description (including the claims, abstract and accompanying drawings that follow) may be replaced with the alternative features which provide the same, equivalent or similar purposes unless otherwise explicitly represented.

In addition, it would be understood by those skilled in the art that although some embodiments described herein comprise some features that are included in other embodiments but not other features, the combination of the features of different embodiments means falling into the scope of the present invention and forming different embodiments. For example, in the claims, any one of the claimed embodiments may be used in a manner of an arbitrary combination.

Embodiments of respective components of the present invention may be implemented with a hardware or a software module executed on one or more processors, or a combination thereof. Those skilled in the art should appreciate that a microprocessor or a digital signal processor (DSP) may be used in practice to realize some or all functions of some modules in an article analysis device according to the embodiments of the present invention. The present invention may also be realized as a device program (e.g. the computer program and the computer program product) for implementing a part or all of the methods described herein. Such a program realizing the present invention may be stored on the computer readable medium or may have a form of one or more signals. Such a signal can be downloaded from Internet websites or provided on carrier signals or in any other forms.

It should be noted that the abovementioned embodiments illuminate the invention and do not pose a limitation on the invention. Moreover, those skilled in the art may design alternative embodiments without separating from the scope of the claims attached. In the claims, any reference symbols between parentheses shall not be configured as limitation on the claims. The word “comprising” does not exclude the existence of components or steps which are not listed in the claims. The words “a” and “an” before the components do not exclude the existence of a plurality of such components. The present invention may be realized by means of a hardware with several different components and a suitably programmed computer. In the unit claims enumerating several devices, several of these devices may be specifically reflected via the same hardware item. The use of the words “first”, “second” and “third” does not indicate any order, and these words may be construed as names.

Described above are only embodiments of the present invention or explanation for the embodiments; however the protection scope of the invention is not limited thereto. Any technicians who are familiar with the art would readily envisage that, within the technical scope disclosed in the invention, variations or alternatives shall all be covered in the protection scope of the invention. The protection scope of the invention shall be defined by that of the claims.

1. A scalable displaying method for a mobile device, comprising:
receiving an instruction to scale down a display of the mobile device; and
scaling down the display on a screen of the mobile device in response to the instruction, by:
outputting, by a graphics processing unit (GPU), pixel data for an entire area of the screen of the mobile device,
wherein pixel data for a first portion of the screen to be activated presents the scaled-down display, and
wherein pixel data for a second portion of the screen causes deactivation of a backlight for the second portion of the screen.

2. The method of claim 1, wherein the instruction is triggered automatically based on a battery status of the mobile device.

3. The method of claim 2, wherein the instruction is triggered when a battery reaches a threshold level.

4. The method of claim 1, wherein the instruction is triggered on-demand by a user of the mobile device selecting an option to scale the display.

5. The method of claim 1, wherein the instruction is triggered by a user of the mobile device selecting an option to operate the mobile device in a reduced power consumption mode that includes operating with a scaled down display.

6. The method of claim 1, wherein the instruction indicates an amount to scale the display.

7. The method of claim 6, wherein the amount is a percentage of an original size of the display.

8. The method of claim 6, wherein the amount is a function of a battery status of the mobile device.

9. The method of claim 8, wherein a size of the display is decreased as a level of a battery decreases.

10. The method of claim 1, wherein the instruction indicates an area of the screen to present the scaled display.

11. The method of claim 1, wherein scaling the display on the screen of the mobile device reduces an activated area of the screen and reduces power consumed by the screen.

12. (canceled)

13. (canceled)

14. A mobile device, comprising:
one or more memories for storing one or more computer programs;
one or more processors that execute the one or more computer programs to perform a scalable displaying method comprising:
receiving an instruction to scale down a display of the mobile device; and
scaling down the display on a screen of the mobile device in response to the instruction, by:
outputting, by a graphics processing unit (GPU), pixel data for an entire area of the screen of the mobile device,
wherein pixel data for a first portion of the screen to be activated presents the scaled-down display, and
wherein pixel data for a second portion of the screen causes deactivation of a backlight for the second portion of the screen.

15. The mobile device of claim 14, wherein the instruction is triggered automatically based on a battery status of the mobile device.

16. The mobile device of claim 14, wherein the instruction is triggered on-demand by a user of the mobile device selecting an option to scale the display.

17. The mobile device of claim 14, wherein the instruction is triggered by a user of the mobile device selecting an option to operate the mobile device in a reduced power consumption mode that includes operating with a scaled down display.

18. The mobile device of claim 14, wherein the instruction indicates an amount to scale the display.

19. The mobile device of claim 14, wherein the instruction indicates an area of the screen to present the scaled display.

20. The mobile device of claim 14, wherein scaling the display on the screen of the mobile device reduces an activated area of the screen and reduces power consumed by the screen.

21. (canceled)

22. (canceled)

23. A non-transitory computer readable storage medium storing computer code executable by at least one processor to perform a scalable displaying method for a mobile device comprising:
receiving an instruction to scale down a display of the mobile device; and
scaling down the display on a screen of the mobile device in response to the instruction, by:
outputting, by a graphics processing unit (GPU), pixel data for an entire area of the screen of the mobile device,
wherein pixel data for a first portion of the screen to be activated presents the scaled-down display, and
wherein pixel data for a second portion of the screen causes deactivation of a backlight for the second portion of the screen.

24. The method of claim 1, wherein the pixel data for the second portion of the screen is black to cause the deactivation of the backlight for the second portion of the screen.
